(19) United States
(12) Patent Application Publication
(10) Pub. No.: US 2025/0075948 A1
(43) Pub. Date: Mar. 6, 2025

(54) ACOUSTIC POWER MODULATION IN A THERMOACOUSTIC MACHINE

(71) Applicant: EQUIUM GROUPE, St Herblain (FR)

(72) Inventor: Thierry LE POLLES, Nantes (FR)

(21) Appl. No.: 18/722,289

(22) PCT Filed: Dec. 20, 2022
(86) PCT No.: PCT/EP2022/086845

§ 371 Date: Jun. 20, 2024

(30) Foreign Application Priority Data
Dec. 21, 2021 (FR) FR2114174

(51) Int. Cl. F25B 9/14

(52) U.S. Cl. CPC F25B 9/145; F25B 2309/1403

(57) ABSTRACT

A thermoacoustic machine including a device for measuring at least one parameter representative of a temperature of a first external source and/or of a second external source, and a control device configured to modulate the acoustic power generated by one or more acoustic sources such that the temperature of one said external source connected to one or more thermoacoustic cells of the machine reaches or remains substantially identical to a setpoint temperature is disclosed.

### TECHNICAL FIELD

The invention relates to the field of thermoacoustic machines.

The invention is particularly advantageous for thermoacoustic machines that are intended to operate in heat pump mode, as opposed to in motor mode. Physically speaking, heat pump mode corresponds to the use of the mechanical energy of a sound wave to pump energy from a thermal source, also known as the pump source, raise its temperature and then dump it at a second thermal source, also known as the dump source, the temperature of the dump source consequently being higher than the temperature of the pump source. A heat pump can be used as a heating system, with the increased temperature of the dump source allowing it to be used as a heating medium, or as a cooling system, with the decreased temperature of the pump source allowing it to be used as a cooling medium.

### PRIOR ART

As is known per se, a thermoacoustic machine is a thermal machine in which, according to the physical principle of thermoacoustics, thermodynamic cycles take place within a working fluid. In motor mode, these cycles generate mechanical energy in the form of an acoustic wave from heat input. In heat pump mode, these cycles generate heat by using the mechanical energy of the acoustic wave.

Conventional thermoacoustic machines that are intended to operate in heat pump mode comprise one or more acoustic sources, which are typically electromechanical actuators or thermoacoustic wave generators, and which configured to generate an acoustic wave within a waveguide containing the working fluid. This acoustic wave provides, in the form of work, the mechanical energy required to simultaneously transfer and raise the temperature of heat drawn from a cold external source to a warm external source.

In modern thermoacoustic machines, such as the one described in U.S. Pat. No. 8,584,471B2, heat transfer is provided by a thermoacoustic cell arranged in the waveguide. The cell comprises a regenerator and two heat exchangers arranged on either side of the regenerator.

During the heat pumping process, the thermodynamic cycle set in motion by the acoustic wave consumes the acoustic work to generate a flow of heat from one end of the regenerator to the other, thereby creating a temperature gradient along the regenerator. The heat exchangers, on the other hand, ensure heat transfer between the working fluid and a heat transport element, such as a heat transfer fluid, connected to a respective external heat source. In particular, one of the exchangers transfers heat from a first heat transfer fluid to a working fluid by pumping heat into a pumping circuit in which this first heat transfer fluid circulates. The other exchanger transfers heat from the working fluid to a second heat transfer fluid by dumping heat into a dumping circuit in which the second heat transfer fluid circulates.

In general, the machine is controlled in an “on-off” manner, i.e. by supplying the acoustic sources with power until the temperature of the dump source—for heating—or the pump source—for cooling—reaches a setpoint temperature, after which the sources stop being controlled for as long as the setpoint temperature is maintained.

### DISCLOSURE OF THE INVENTION

The invention aims to improve the energy efficiency of a thermoacoustic machine, in particular of a thermoacoustic machine operating in heat pump mode.

To this end, one subject of the invention is a thermoacoustic machine comprising:
a waveguide intended to receive a working fluid,
an acoustic source configured to generate an acoustic wave so as to propagate acoustic energy through the waveguide, and
a thermoacoustic cell comprising a regenerator, a first heat exchanger which is configured to exchange heat between the working fluid and a first heat transport element transporting heat to a first external source, and a second heat exchanger which is configured to exchange heat between the working fluid and a second heat transport element transporting heat from a second external source.

According to the invention, the machine comprises a device for measuring at least one parameter representative of a temperature of the first external source and/or of the second external source, and a control member configured to modulate the acoustic power of the acoustic source so as to modify the temperature of the first external source and/or of the second external source according to the at least one parameter.

The invention allows the machine to be controlled while reducing or eliminating interruptions in the supply of power to the acoustic source.

More specifically, the invention makes it possible to reach a target temperature in the first or second external source and to maintain this temperature in a range around the target temperature by modifying the acoustic power generated by the acoustic source.

For example, when the machine is used to heat a space formed by the first external source, the control member can be configured to reduce the acoustic power to a non-zero value when the space reaches a setpoint temperature and, if the temperature of the space subsequently drops, to increase the acoustic power by the amount required to reach the setpoint temperature again.

Similarly, when the machine is used to cool a space formed by the second external source, the control member can be configured to reduce the acoustic power to a non-zero value when the space reaches a setpoint temperature and, if the temperature of the space subsequently rises, to increase the acoustic power by the amount required to reach the setpoint temperature again.

In a non-limiting manner, said at least one parameter can be selected from among the following parameters:
a temperature of the first heat transport element,
a temperature of the second heat transport element,
a temperature of the first external source,
a temperature of the second external source,
a temperature of the working fluid, and
an acoustic pressure of the working fluid.

In one embodiment, the acoustic source comprises a motor provided with a movable element, the control member being configured to modify an amplitude and/or frequency of movement of this movable element.

According to a first variant, the motor is an electric motor, for example a linear motor.

In the context of this first variant, the movable element can be a piston, for example a single- or double-acting piston.

According to a second variant, the motor is a rotary motor.

In one embodiment, the control member is more specifically configured to modify the amplitude of a voltage and/or of a current supplied to the acoustic source, so as to modulate the acoustic power that it generates.

The acoustic source can also be a thermoacoustic heat engine.

Thus, in one embodiment, said thermoacoustic cell is a first thermoacoustic cell, the acoustic source being formed by a second thermoacoustic cell, this second thermoacoustic cell comprising a regenerator, a first heat exchanger which is configured to exchange heat between the working fluid and a third heat transport element transporting heat to a third external source, and a second heat exchanger which is configured to exchange heat between the working fluid and a fourth heat transport element transporting heat from a fourth external source.

In such a case, the control member is preferably configured to modify an amount of heat transported by the third heat transport element and/or the fourth heat transport element.

Modifying the amount of heat in this way makes it possible to modify the temperature gradient within the second thermoacoustic cell, thereby modulating the acoustic power that it generates.

The third and fourth external sources can each be different from both the first external source and the second external source. Alternatively, the third or fourth external source can be identical to one from among the first external source and the second external source in order to form a trithermal machine.

In one embodiment, the third heat transport element and the fourth heat transport element each comprise a heat transfer fluid, the control member being configured to modify a temperature and/or a flow rate of the heat transfer fluid of the third heat transport element and/or of the fourth heat transport element.

Another subject of the invention is a method for controlling such a thermoacoustic machine.

This method preferably comprises a modulation step which comprises:
measuring said at least one parameter,
comparing a value of at least one parameter thus measured with a reference value,
controlling the acoustic source so as to modulate the acoustic power that it generates if these values are different in order to modify the temperature of the first external source and/or of the second external source.

Said reference value can be a predetermined value or a previously measured value.

When the reference value is predetermined, it can be variable and dependent on an external factor such as the day or night period, inter alia.

In one embodiment, the modulation step is repeated over time.

This reference value is preferably a setpoint value.

In other words, the invention can be implemented such that the temperature of the first external source and/or of the second external source reaches a setpoint temperature and/or such that this temperature remains the same as or close to such a setpoint temperature.

Further advantages and features of the invention will become apparent from the following detailed, non-limiting description.

### BRIEF DESCRIPTION OF THE DRAWINGS

The following detailed description makes reference to the accompanying drawings in which:

FIG. 1 is a schematic view of an installation comprising a thermoacoustic machine according to a first embodiment of the invention, this machine comprising four acoustic engines and four thermoacoustic heat pump cells;

FIG. 2 is a schematic view of an installation comprising a thermoacoustic machine according to a second embodiment of the invention, this machine comprising two heat engines and two thermoacoustic heat pump cells.

### DETAILED DESCRIPTION OF EMBODIMENTS

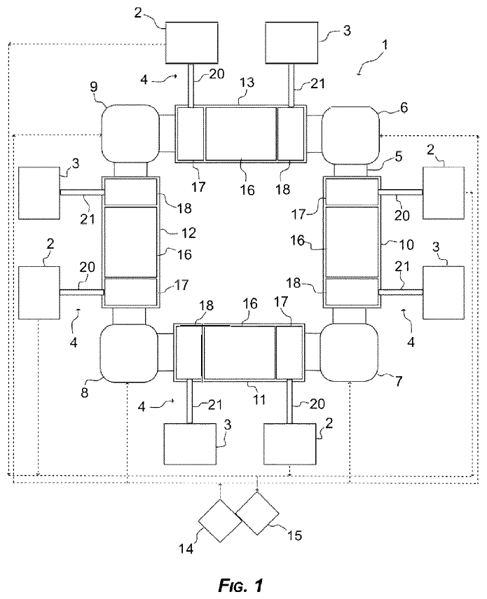

FIG. 1 schematically shows an installation comprising a thermoacoustic machine 1, external sources 2 and 3 and a distribution network 4 connecting the machine 1 to the external sources 2 and 3.

The thermoacoustic machine 1 is intended to operate in heat pump mode, in the physical sense of the expression.

Generally speaking, the machine 1 comprises a waveguide 5, four acoustic sources 6, 7, 8 and 9, four thermoacoustic cells 10, 11, 12 and 13, a control member 14 and a measuring device 15.

Each of the thermoacoustic cells 10 to 13 comprises a regenerator 16, a first heat exchanger 17 and a second heat exchanger 18.

In this example, the waveguide 5 is a tube defining an internal space, in a closed loop, forming an acoustic waveguide.

The internal space of the waveguide 5 contains a pressurized working fluid for the propagation of an acoustic wave. The working fluid can be a monatomic gas, a polyatomic gas such as a mixture comprising helium and argon or another mixture, or else a mixture of a gas and a liquid.

This type of geometry for the waveguide 5, which is by no means limiting, promotes the formation of a progressive wave and, more specifically, allows a progressive wave to be obtained locally at the regenerators 16.

The waveguide 5 is preferably made of a material such as a metal alloy or another material that can contain the working fluid under pressure.

The acoustic sources 6 to 9 and the thermoacoustic cells 10 to 13 are arranged in series along the waveguide 5, in alternation, such that each of the cells 10 to 13 is arranged between two respective acoustic sources 6 to 9.

In this example, each of the acoustic sources 6 to 9 is a linear motor comprising a piston-type movable element.

Each of the sources 6 to 9 is configured to generate an acoustic wave in the working fluid, as a result of piston displacement, so as to propagate acoustic energy through the waveguide 5.

For each of the thermoacoustic cells 10 to 13, the regenerator 16 and the heat exchangers 17 and 18 are arranged in the waveguide 5 in such a way that the working fluid passes through them to allow thermoacoustic energy conversion.

The regenerator 16 is a porous structure, i.e. a structure provided with pores, cavities or openings in order to increase or maximize the area of contact, and therefore of exchange, with the working fluid, while minimizing head losses.

By way of example, the regenerator 16 of each of the cells 10 to 13 can to this end comprise a stack of plates or gratings, made of a material with a high heat capacity and low thermal conductivity, for example stainless steel or a ceramic material.

In operation, the regenerators 16 act as thermal sponges with respect to the working fluid, alternately storing and releasing heat.

For each of the thermoacoustic cells 10 to 13, the heat exchangers 17 and 18 are arranged on either side of the regenerator 16 in such a way that heat can be exchanged between the working fluid and a respective heat transport element at the ends of the regenerator 16.

More precisely, for each of the cells 10 to 13, the first heat exchanger 17 is, in this example, configured to exchange heat between the working fluid and a first heat transport element formed by a heat transfer fluid circulating in a pipe 20 connected to the external source 2, while the second heat exchanger 18 is configured to exchange heat between the working fluid and a second heat transport element which is also formed by a heat transfer fluid circulating in a pipe 21 connected to the external source 3.

To achieve such heat exchange, each of the heat exchangers 17 and 18 can comprise, in a manner known per se, conductive elements that form, for example, a stack of fins in contact with the working fluid. Such fins can be made of a conductive metal such as copper or aluminum.

Thus, the pipes 20 and 21, which form said distribution network 4, allow heat to be transported between the working fluid and, respectively, the sources 2 and 3 which are external to the machine 1, via the heat transfer fluid circulating in these pipes.

In one variant not shown, the first and/or second heat transport element can, instead of a heat transfer fluid, be a solid element such as fins, part of which forms, or is connected to, the distribution network 4.

In one variant, the distribution network 4 comprises a heat pipe (not shown).

In this example, the external sources 2 are dump sources which together form a space to be heated, and the external sources 3 are pump sources formed by an external space that forms an air or water thermal reservoir which is relatively cold with respect to the air circulating in the space. In other words, the pipes 20 associated with the thermoacoustic cells 10 to 13 form a parallel arrangement in this example. Similarly, the pipes 21 associated with the thermoacoustic cells 10 to 13 form a parallel arrangement. Alternatively, a series arrangement can be implemented (not shown).

The sources 2 and 3 thus form thermal reservoirs outside the machine 1.

Of course, the machine 1 can also be used to cool a space instead of heating it. Thus, in one variant, the pump sources 3 can together form a space to be cooled, and the dump sources 2 can be formed by an external space that forms an air or water thermal reservoir which is relatively warm with respect to the air circulating in the space. The present description applies by analogy to such an implementational variant.

An example of the operation of the installation shown in FIG. 1 for heating the space 2 will now be described.

The control member 14 is operated so as to control the motors 6 to 9 in order to move their pistons according to a periodic function which, in this example, is a sinusoidal function of the type Xᵢ(t)=Aᵢ sin(2πfᵢt+φᵢ), where i is the number of the source (in this example, source 6 has number i=1, source 7 has number i=2, source 8 has number i=2 and source 9 has number i=4), t is the time, Xᵢ is the position of the piston of the source i, Aᵢ is the amplitude of the displacement of the piston of the source i, fᵢ is the frequency of the displacement of the piston of the source i and φᵢ is the phase associated with the displacement of the piston of the source i.

In a non-limiting manner, it is assumed that f₁=f₂=f₃=f₄ and A₁=A₂=A₃=A₄.

The displacement of the piston of motor 7 is out of phase with the displacement of the piston of motor 6, the displacement of the piston of motor 8 is out of phase with the displacement of the piston of motor 7, the displacement of the piston of motor 9 is out of phase with the displacement of the piston of motor 8 and the displacement of the piston of motor 6 is out of phase with the displacement of the piston of motor 9.

In this non-limiting example, the value of this phase offset is, respectively, Δ_{φ}=φ₂−φ₁=φ₃−φ₂=φ₄−φ₃=φ₁−φ₄=−π/2.

By controlling the sources 6 to 9 in this way, acoustic energy is propagated through the waveguide 5 in a direction of propagation that produces a progressive or near-progressive acoustic wave in the regenerator 16 of each of the thermoacoustic cells 10 to 13 moving in a direction from the exchanger 17 to the exchanger 18.

In a manner known per se, the propagation of acoustic energy in this way gives rise to a Stirling-type thermal cycle involving, within each of the cells 10 to 13, conversion of thermoacoustic energy associated with a transfer of heat, on the one hand, from the heat transfer fluid circulating in the pipe 21 to the working fluid via the heat exchanger 18 and, on the other hand, from the working fluid to the heat transfer fluid circulating in the pipe 20 via the heat exchanger 17, i.e. pumping heat from the external space 3 and dumping heat in the space 2.

In this way, the machine 1 heats the space 2 such that the air that it contains reaches a setpoint temperature.

According to the invention, the machine 1 makes it possible to modify the temperature of the space 2, in particular to increase it when it is below the setpoint temperature and to reduce it when it is above the setpoint temperature, by modulating the acoustic power generated by the motors 6 to 9.

In this particular example, the measuring device 15 is configured to measure the temperature of the space 2.

The temperature of the space 2 measured in this way is compared with the setpoint temperature using a computing means (not shown) of the machine 1.

If these two temperature values are different, or if the absolute difference between these two values is greater than a predetermined threshold, e.g. 1° C., the acoustic power of the motors 6 to 9 is modified, i.e. lowered if the temperature of the space 2 is higher than the setpoint temperature and increased if the temperature of the space 2 is lower than the setpoint temperature.

This process of measuring, comparing and modifying acoustic power constitutes a modulation step that can be repeated continuously over time.

The machine 1 thus allows heat to be pumped from the external source 3 to heat the space 2 so as to reach the setpoint temperature and maintain a temperature at or close to the setpoint temperature over time without the need to interrupt the supply of power to the motors 6 to 9 when the setpoint temperature is reached and then to start supplying them with power again when the temperature of the space 2 deviates from the setpoint temperature, or at least while reducing the number of interruptions needed.

In this non-limiting example, the control member 14 is more specifically configured to modulate the acoustic power of the motors 6 to 9 by modifying the amplitude of the supply voltage thereof so as to modify the amplitude of displacement of the piston thereof.

Of course, this acoustic power modulation can be achieved by modifying other control parameters of the motors 6 to 9, such as the amplitude of the supply current and/or the phase thereof. In addition, particularly in embodiments (not shown) in which the motors 6 to 9 are rotary motors, the acoustic power modulation can result from a modification of the frequency and/or of the amplitude of displacement of the movable element of the motors 6 to 9. In addition, other parameters can also be modulated in order to modify the temperature of the external sources 2 and/or 3, for example the flow rate and/or the temperature of the heat transfer fluid circulating in the pipe 20 and/or in the pipe 21 that are connected to one or more of the thermoacoustic cells 10 to 13.

Furthermore, the measuring device 15 can be configured to measure one or more parameters other than the temperature of the external sources 2, such as the temperature of the heat transfer fluid circulating in the pipe 20 and/or in the pipe 21 that are connected to one or more of the thermoacoustic cells 10 to 13, the temperature and/or the acoustic pressure of the working fluid, and/or the temperature of the external sources 3, in particular when these form a space to be cooled.

More generally, the acoustic power modulation of the machine 1, with a view to reaching a setpoint temperature in the external sources 2 and/or 3, is carried out according to one or more parameters representative of the temperature of the external sources 2 and/or 3, including, but not limited to, the parameters listed above.

In some variants not shown the acoustic sources 6 to 9 of the machine 1 of FIG. 1 can comprise actuators other than linear motors, for example rotary motors. In addition, the movable element of the acoustic source can be a single- or double-acting piston, inter alia.

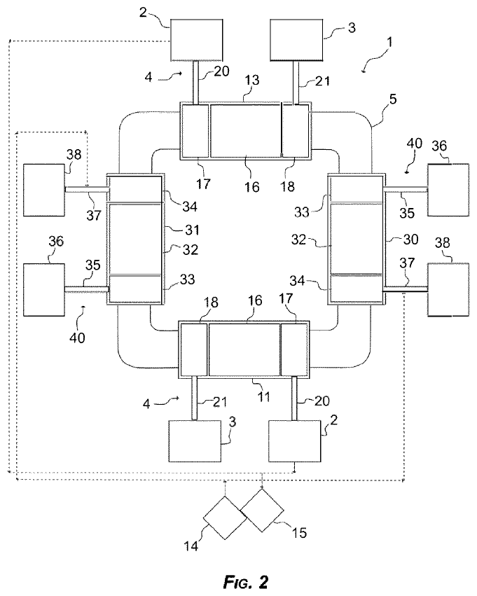

FIG. 2 illustrates a second embodiment which differs from the embodiment of FIG. 1 in that the machine 1 comprises not four but two thermoacoustic heat pump cells 11 and 13, and in that it comprises not four acoustic sources but two acoustic sources 30 and 31, which in this example are heat engines.

The foregoing description applies by analogy to this second embodiment, which is described essentially in terms of its differences from that of FIG. 1.

With reference to FIG. 2, the acoustic sources 30 and 31 and the thermoacoustic cells 11 and 13 are arranged in series along the waveguide 5, in alternation, such that each of the cells 10 and 13 is arranged between the acoustic sources 30 and 31 and vice versa.

The acoustic sources 30 and 31 are each formed by a thermoacoustic cell of the same type as the cells 11 to 13 described above. Thus, each of the cells 30 and 31 comprises a regenerator 32, a first heat exchanger 33 and a second heat exchanger 34, which are arranged in the waveguide 5 in such a way that the working fluid passes through them to allow thermoacoustic energy conversion.

For each of the sources 30 and 31, the first heat exchanger 33 is configured to exchange heat between the working fluid and a third heat transport element consisting of a heat transfer fluid circulating in a pipe 35 that is connected to an external source 36. The second heat exchanger 34 is configured to exchange heat between the working fluid and a fourth heat transport element consisting of a heat transfer fluid circulating in a pipe 37 that is connected to an external source 38.

The pipes 35 and 37 form a distribution network 40 which is separate from the distribution network 4 of the thermoacoustic cells 11 and 13.

Furthermore, the external sources 36 and 38, which form thermal reservoirs outside the machine 1, are, in this example, separate from the external sources 2 and 3 to which the thermoacoustic cells 11 and 13 are connected. In one variant, the external sources 2 and 36 are identical.

In this example, the external sources 36 are dump sources containing a relatively cold fluid, and the external sources 38 are sources supplying heat by means of a relatively warm fluid.

The machine 1 makes it possible to cool/air-condition a space formed by the external sources 3, which in this instance form pump sources, and the external sources 2 form dump sources.

To achieve this, the control member 14 of the machine 1 is in this case configured to modify the temperature and/or the flow rate of the heat transfer fluid circulating in the pipes 37 that are connected to the engines 30 and 31 so as to modify the amount of heat transferred by this heat transfer fluid.

This results in a change in the thermal gradient between the ends of the regenerator 32 of each of these engines 30 and 31, leading to a change in the acoustic power generated by the engines 30 and 31.

In a manner known per se, such a thermal gradient makes it possible to generate and maintain an acoustic wave in the working fluid so as to propagate acoustic energy through the waveguide 5.

In this example, the acoustic energy travels in a direction of propagation that produces a progressive or near-progressive acoustic wave in the regenerator 16 of each of the thermoacoustic cells 11 and 13 from the exchanger 17 to the exchanger 18.

The thermoacoustic cells 11 and 13 can thus carry out thermoacoustic energy conversion as described above so as to pump heat from the space 3 and dump it into the external space 2, allowing the space 3 to be cooled such that the air that it contains reaches a setpoint temperature.

In this example, the measuring device 15 is configured to measure the temperature of the space 3, and the machine 1 can carry out said modulation step by controlling the supply of power to the heat engines 30 and 31, in this example by modifying the temperature and/or the flow rate of the heat transfer fluid circulating in the pipes 37.

Numerous variants apply to this second embodiment, in particular by applying, by analogy, the variants of the first embodiment that are described above. For example, the distribution network 4 and/or 40 can comprise a heat pipe (not shown). As a further example, the sources 30 and 31 and the cells 11 and 13 can be arranged differently from one another, with the sources 30 and 31 following one another and the cells 11 and 13 following one another, as opposed to the alternating arrangement shown in FIG. 2.

The embodiments and variants described hereinbefore can also be combined with one another. For example, the machine 1 can comprise one or more linear and/or rotary motors and/or one or more heat engines. Of course, the machine 1 can comprise a different number of acoustic sources and/or of thermoacoustic cells. In addition, the various components of this machine can differ structurally and/or geometrically from the foregoing description.

1. A thermoacoustic machine comprising:
a waveguide intended to receive a working fluid;
an acoustic source configured to generate an acoustic wave so as to propagate acoustic energy through the waveguide;
a thermoacoustic cell comprising a regenerator, a first heat exchanger which is configured to exchange heat between the working fluid and a first heat transport element transporting heat to a first external source, and a second heat exchanger which is configured to exchange heat between the working fluid and a second heat transport element transporting heat from a second external source;
a device for measuring at least one parameter representative of a temperature of the first external source and/or of the second external source; and
a control member configured to modulate the acoustic power of the acoustic source so as to modify the temperature of the first external source and/or of the second external source according to the at least one parameter.

2. The machine as claimed in claim 1, wherein the at least one parameter is selected from among the following parameters:
a temperature of the first heat transport element,
a temperature of the second heat transport element,
a temperature of the first external source,
a temperature of the second external source,
a temperature of the working fluid, and
an acoustic pressure of the working fluid.

3. The machine as claimed in claim 1, wherein the acoustic source comprises a motor provided with a movable element, the control member being configured to modify an amplitude and/or frequency of movement of this movable element.

4. The machine as claimed in claim 1, wherein said thermoacoustic cell is a first thermoacoustic cell, the acoustic source being formed by a second thermoacoustic cell, said second thermoacoustic cell comprising a regenerator, a first heat exchanger which is configured to exchange heat between the working fluid and a third heat transport element transporting heat to a third external source, and a second heat exchanger which is configured to exchange heat between the working fluid and a fourth heat transport element transporting heat from a fourth external source, the control member being configured to modify an amount of heat transported by the third heat transport element and/or the fourth heat transport element.

5. The machine as claimed in claim 4, wherein the third heat transport element and the fourth heat transport element each comprise a heat transfer fluid, the control member being configured to modify a temperature and/or a flow rate of the heat transfer fluid of the third heat transport element and/or of the fourth heat transport element.

6. A method for controlling a thermoacoustic machine as claimed in claim 1.

7. The method as claimed in claim 6, comprising a modulation step which comprises:
measuring said at least one parameter,
comparing a value of at least one parameter thus measured with a reference value; and
controlling the acoustic source so as to modulate the acoustic power that it generates if these values are different in order to modify the temperature of the first external source and/or of the second external source.

8. The method as claimed in claim 7, wherein the modulation step is repeated over time.

9. The method as claimed in claim 7, wherein the reference value is a setpoint value.
